(19) United States
(12) Patent Application Publication
(10) Pub. No.: US 2010/0104369 A1
(43) Pub. Date: Apr. 29, 2010

(54) Thermal Driven Soil Venting System

(76) Inventor: Youzhi Chen, San Francsico, CA (US)

Correspondence Address: YOUZHI CHEN, 1 CRESCENT WAY, APT 1116, SAN FRANCISCO, CA, 94134, US

(21) Appl. No.: 12/257,345

(22) Filed: Oct. 23, 2008

(51) Int. Cl. B09C 1/06

(52) U.S. Cl. 405/128.85

(57) ABSTRACT

A soil venting system driven by air thermal property is developed to deaf with tow concentration gaseous hazard materials in unsaturated zone of soil. A process utilizes the thermal driven soil venting system to create air gradient in the unsaturated zone of soil and force the gaseous hazard materials out the contaminated soil.

### DESCRIPTION OF FIGURES

FIG. 1 is a schematic cross section view of the present invention for removal gaseous contamination of unsaturated zone

FIG. 2 is a schematic plant view of the present invention for removal gaseous contamination of unsaturated zone

FIG. 3 is a schematic of injection function of heating chamber

FIG. 4 a schematic of extraction function of heating chamber

FIG. 5 a schematic of inlet check valve detail of heating chamber as injection apparatus

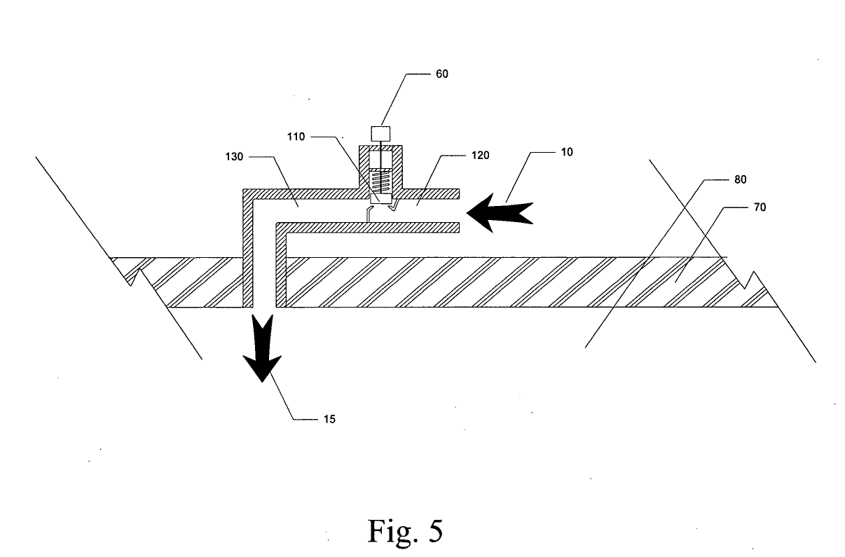

FIG. 6 a schematic of outlet check valve detail of heating chamber as injection apparatus

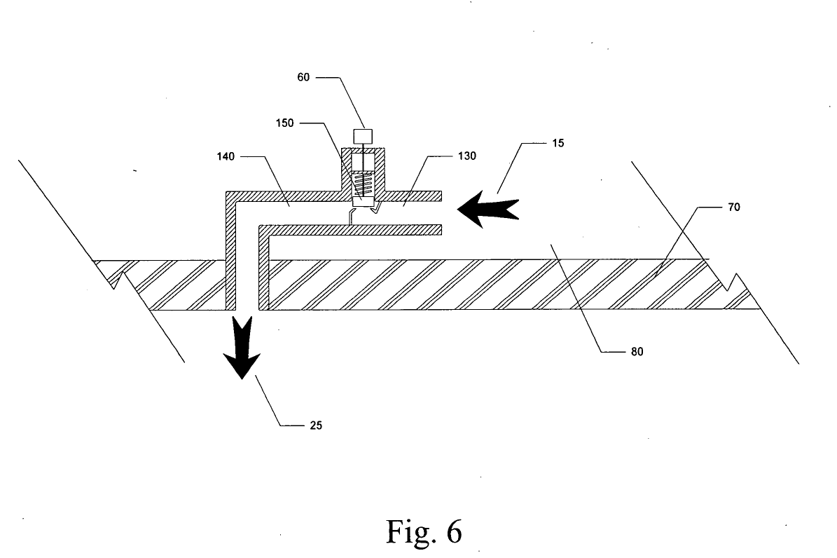

FIG. 7 a schematic of inlet check valve detail of heating chamber as extraction apparatus

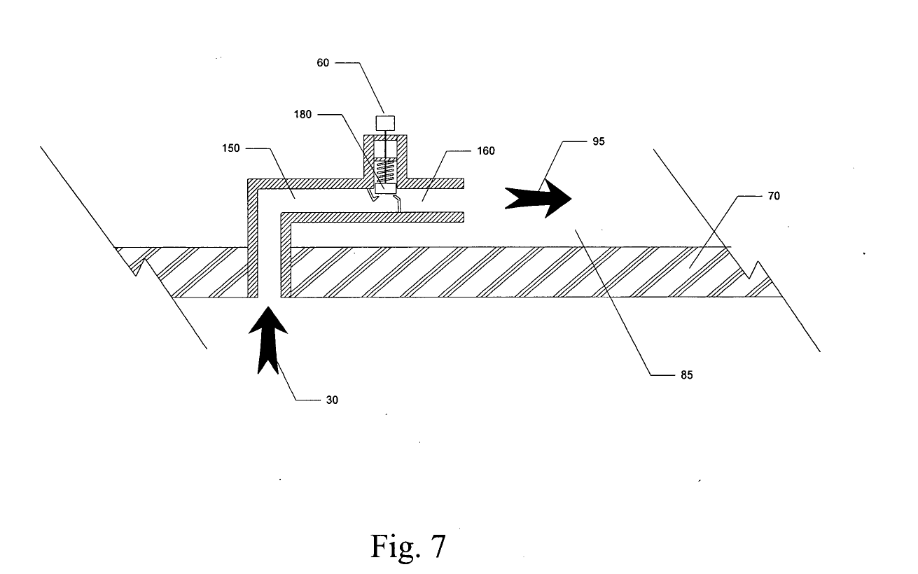

FIG. 8 a schematic of outlet check valve detail of heating chamber as extraction apparatus

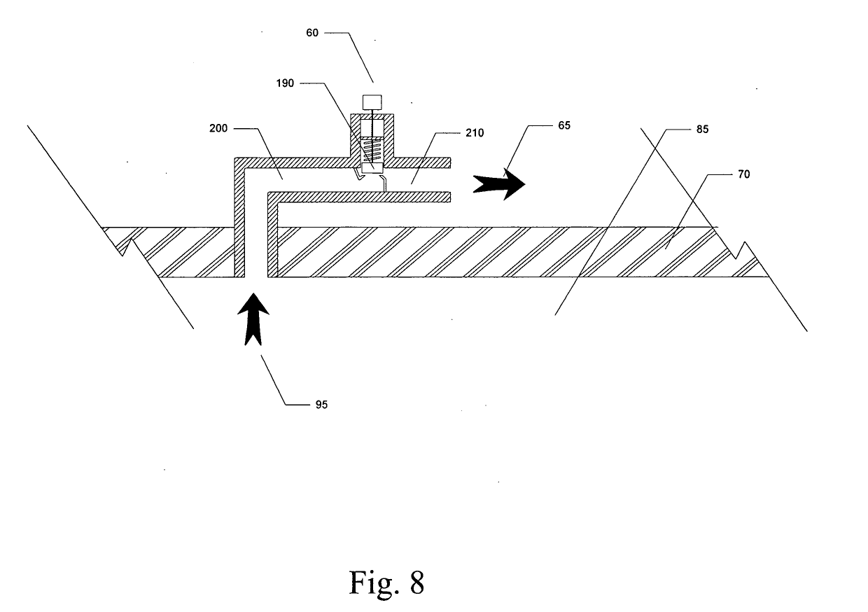

### FIELD OF INVENTION

This invention relates to a system employing thermal properties of air for controlling and reducing volatile organics compounds (VOCs), semi-volatile compound (sVOCs) and other gaseous hazard materials in unsaturated zone of soil.

### BACKGROUND OF THE INVENTION

There are quite a few mature methods for clean up VOCs, sVOCs and other gaseous hazard materials in contaminated unsaturated zone (EPA, 2004). The methodologies involve technologies either use air movement in the porous materials to drive the contaminations out or apply chemical or biological agents to degrade molecular structure of hazardous materials into harmless chemicals. Since fate of 70s, the remediation processes have developed and been used to treat thousands and thousands contaminated sites.

Generally, existing methodologies require expensive machinery or costly chemical agent as weft as intensive maintenance and monitoring. With price tag of tens thousands dollars, it is not economically feasible to install the remediation system when the contamination is tow or to operate a system for tong period of time. Under such circumstance, tow concentration sites are in disadvantage when the resources are limited and some remediation systems have to shut down before the soil really free of hazard materials. Since the hazard materials at tow concentration either exist in small pores or are absorbed on surface of soil particles, the release rate of the contaminations is relatively stow. In other words, it is not efficient to use existing methodologies to remedy the tow contaminated area even if the economical feasibility is not in consideration. It is objective for the invention to provide a tow cost and tow maintenance system to deaf with gaseous contamination in unsaturated zone.

### SUMMARY OF THE INVENTION

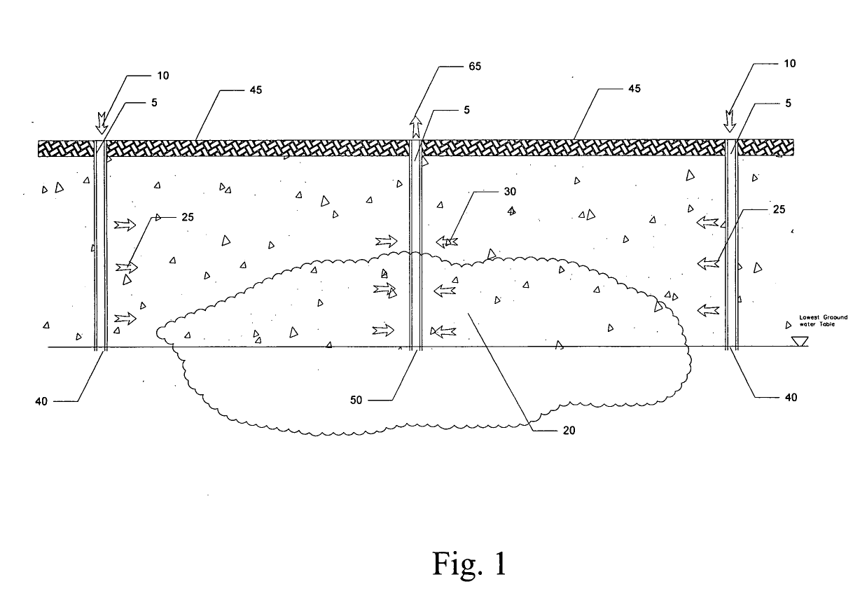

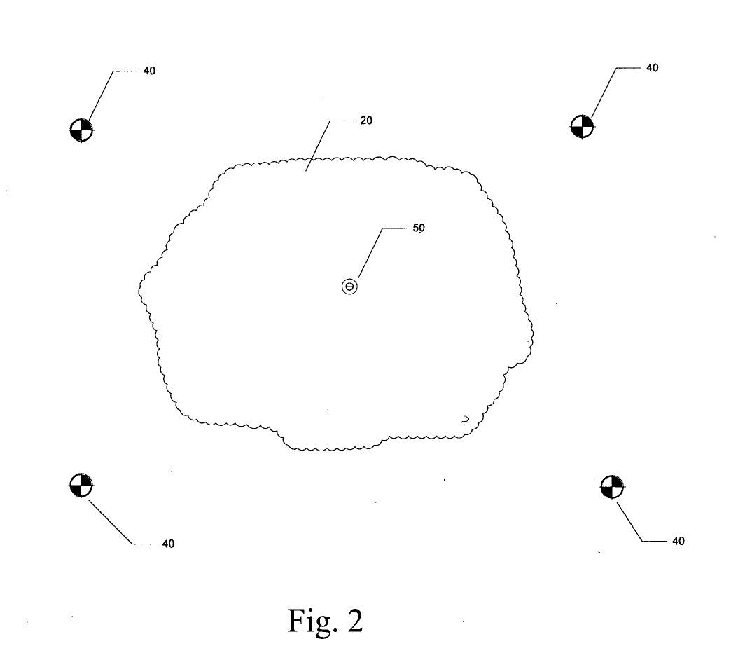

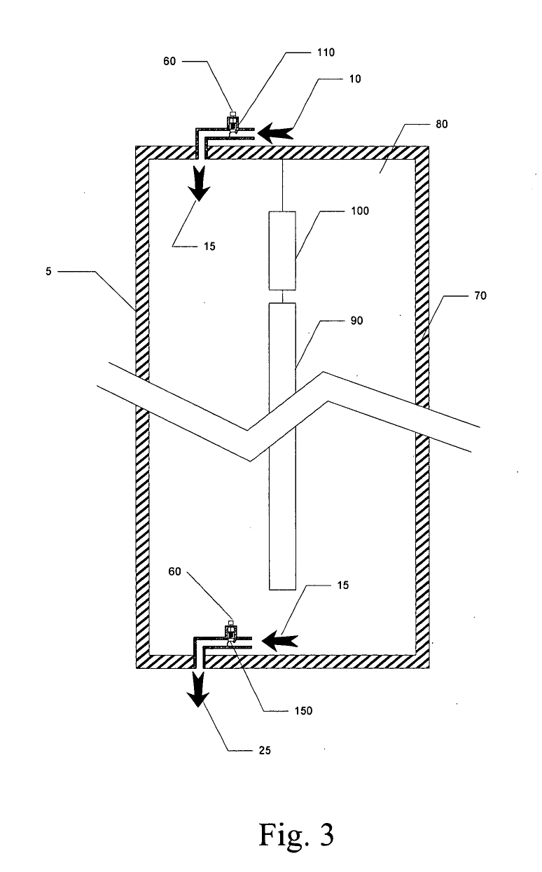

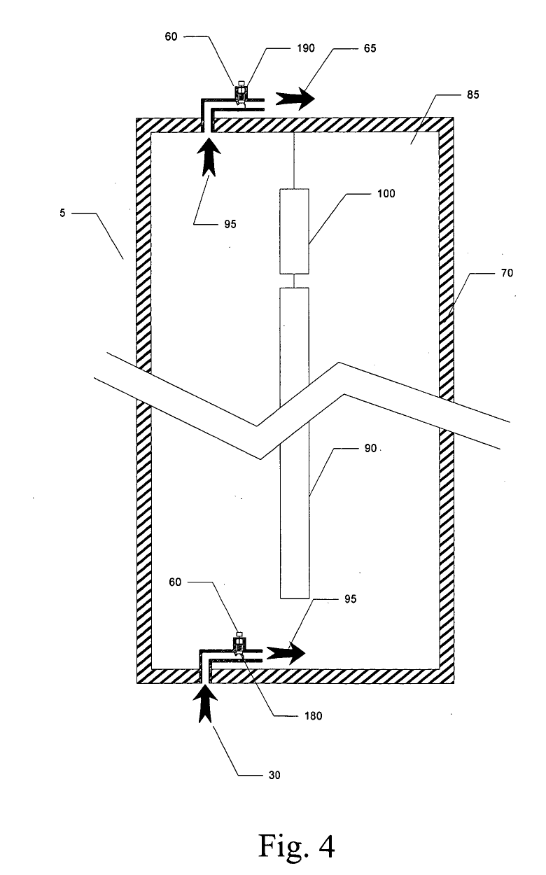

A heating chamber 5 is designed to drive fresh air 10 into contaminated unsaturated soil 20 and/or extract air 30 with hazard materials through the injection wefts 40 and extraction wefts 50 installed in the contaminated area (FIG. 1 and FIG. 2). The chambers are operated by thermal property of the air. A pair of check valves 60 are used to assure the air only flow one direction (FIG. 3 and FIG. 4). It is object for the invention to form an air pressure gradient in the porous media so as for the air contained in the porous media to flow at a desired direction and remove gas phased contaminations. It is also object for the invention to provide a means to deliver gaseous decontamination agents into the porous media with contamination to accelerate natural attenuation.

### DESCRIPTION OF THE INVENTION

The invention use air thermodynamic properties as driving force. Special designed chambers 5 are coupled on wefts installed in the concerned area (FIG. 1 and FIG. 2). The chambers are consisted of a seated container 70, a pair of check valves 60 and a set of heating apparatus 90 with temperature control device 100 (FIG. 3 and FIG. 4). The check valves are arranged as such that the air flow in the chamber will only flow one direction (FIG. 3 and FIG. 4).

Heating process of the chamber is in sequence of heating and cooling. When discharge valve of the heating chamber is connected with underground pipes, it serves injection function to push the fresh air or/and decontamination agents into the unsaturated zone. When recharge valve of the heating chamber is connected with the underground pipes, however, it serves extraction function to extract gaseous contamination out from the unsaturated zone.

During the injection function, the air 15 inside the heating chamber is expanded in the heating cycle. With increased pressure, the gate 110 is pushed open. Air 15 flows out the heating chamber 80 from opening 120 to opening 130 through gate 110. When the preset temperature is reached, the temperature control device will disable the heating apparatus. Duo to dropped temperature, tow pressure is created in the chamber. The tow pressure will close the gate 110 and open gate 150. Air 10 with ambient temperature recharges into the chamber from opening 130 to opening 140 through gate 150. The air will further coot down the chamber. White either the preset tow temperature is reached or preset time period is elapsed, the heating process starts again.

When serving extraction function, the cooling cycle is working cycle. During the heating cycle, expanded air 95 pushes gate 180 open. The air 95 flows out the heating chamber 85 from opening 160 to opening 170. The heating apparatus will be disabled at a preset temperature. The dropped temperature will create tow pressure in the heating chamber 85 and close the gate 180. In the mean time, the gate 190 is pushed open. The tow pressure draw the air 30 in the casing of extraction weft 50 from opening 200 to opening 210 through gate 190. When the heating cycle starts again, the expanded air will push close gate 190 and reopen the gate 180.

By adjusting the size of the heating chamber and power of the heating apparatus, the volume of injected air can be adjusted. The bigger the heating chamber and the more powerful the heating apparatus, the more air is pushed. The injection pressure will depend on the preset maximum temperature of the heating chamber. With higher temperature setting, the heated air in the chamber can achieve higher pressure.

The injection/extraction through the underground pipes will create air pressure gradient in concerned unsaturated zone of the soil. To achieve better clean up result, some accessory devices can be used. An oxygen diffuser can be added into the chamber. The oxygen rich air will be pushed into the unsaturated zone to increase the rate of the VOCs and SVOCs biodegrading. An ozone generator can also be attached to the chamber. The air flow created by heating chamber will enhance the diffusion of ozone and boost the clean up process.

For some application requiring only limited amount air passing through, a solar panel may be used as heating apparatus. The daily temperature fluctuation will proceed as natural heating/cooling system.

I claim:

1. A system for removal of gaseous contamination from unsaturated zone of soil by means of thermodynamic changes of air, the system consist of:
a) One or more set of underground pipes
b) Each set of pipes is coupled with a heating chamber

2. Said underground pipe as defined in claim 1 has at feast one opening within unsaturated zone

3. Said heating chamber as defined in claim 1 consist of
a) an air tight container
b) a heating apparatus
c) a temperature control apparatus which turn on said heating apparatus at tow temperature and turn off said heating apparatus at high temperature
d) a timer to turn on and off said heating apparatus at given time interval
e) at feast two check valves to control the air follow into said air tight container through preset inlet opening and out said air time container through preset outlet opening

4. Said heating chamber with said preset inlet opening as defined in claim 3 joined with said underground pipe as defined in claim 2 is function as injection apparatus to force clean air into said unsaturated zone

5. Said heating chamber with said preset outlet opening as defined in claim 3 joined with said underground pipe as defined in claim 2 is function as extraction apparatus to withdraw air with gaseous hazard materials from said unsaturated zone

6. Said heating chamber as defined in claim 3 is also comprised of an oxygen dispenser to supply oxygen to said injection apparatus as defined in claim 4 at preset concentration

7. Said heating chamber as defined in claim 3 is also comprised of an ozone generator to supply ozone to said injection apparatus as defined in claim 4 at preset concentration

8. Said heating chamber as defined in claim 3 as said extraction apparatus as defined in claim 5 is also comprised of decontaminating chamber

9. A process employing thermal properties of air to force fresh air into unsaturated zone of soil and extract gaseous contaminations out from said unsaturated zone

10. A process further employing thermal properties of air to force additional decontamination agent into unsaturated zone of soil

11. A process further employing thermal decontamination to treat extracted gaseous contamination

12. Provide a heating chamber with
a) a air tight confinement vessel
b) a set of check valve
c) a set of temperature control apparatus
d) a time
e) a heating apparatus

13. Provide at feast one set of pipe with at feast opening in said unsaturated zone

14. Provide at feast one heating chamber connected to each said pipe

15. Provide heating and cooling cycle in said heating chamber
a) Said heating cycle means said heating apparatus is enabled to heat the air in said heating chamber
b) Said cooling cycle means said heating apparatus of said heating chamber is disabled

16. Provide check valves installed on said heating chamber with the intention that the heated air discharged from said heating chamber through one set of check valves as discharge port and the unheated air recharge into said heating chamber through another set of check valves as recharge port

17. Provide injection apparatus with discharge check valves as defined in claim 16 connected with said pipe as defined in claim 13

18. Provide extraction apparatus with recharge check valves as defined in claim 16 connected with said pipe as defined in claim 13

19. Provide additional oxygen supply apparatus with said injection apparatus as defined in claim

20. Provide additional ozone supply apparatus with said injection apparatus as defined in claim

21. Provide decontamination apparatus with said extraction apparatus as defined in claim 18
